(19) United States
(12) Patent Application Publication
(10) Pub. No.: US 2008/0157527 A1
(43) Pub. Date: Jul. 3, 2008

(54) METHODS AND APPARATUS FOR OPERATING ENGINE DRIVEN VEHICLES

(76) Inventors: Michael Lewis Jones, Roanoke, IN (US); James Edward O'Bryan, Fort Wayne, IN (US); Lokesh Ramanna, Bangalore (IN)

Correspondence Address: PATRICK W. RASCHE (12552), ARMSTRONG TEASDALE LLP, ONE METROPOLITAN SQUARE, SUITE 2600, ST. LOUIS, MO, 63102-2740, US

(21) Appl. No.: 11/617,888

(22) Filed: Dec. 29, 2006

(51) Int. Cl. H02K 23/52; F02N 11/04

(52) U.S. Cl. 290/34

(57) ABSTRACT

Methods and apparatus for controlling electrical energy in an engine-driven vehicle are provided. The vehicle includes a battery, a propulsive engine, and a starter-generator assembly coupled to the engine of the vehicle. The method includes supplying an electrical current from the battery to a starting winding of the starter-generator, supplying an electrical current to the battery from a generating winding of the starter-generator, and controlling the voltage of the starter-generator using a unitary, voltage regulator integrated with the starter-generator.

### BACKGROUND OF THE INVENTION

This invention relates generally to engine-driven vehicles and more particularly to a starter-generator and voltage regulator for an engine-driven vehicle.

Engine-driven vehicles typically include an engine, a starter-generator coupled to the engine to facilitate starting the engine and providing electrical energy to vehicle auxiliaries, a voltage regulator to control the generator voltage, and a battery. The various components are interconnected using a plurality of wires which may be assembled into a complex bundle, i.e. a wiring harness, installed in the vehicle.

In at least one known engine-driven vehicle manufacturing formation process, several assembly steps are used to install the plurality of components and to electrically connect the components. At each assembly step, man-hours are expended to install the components and electrically connect the components in the complex wiring system. Additionally, repairing or replacing individual components can be costly and time consuming to the owner of the vehicle.

### BRIEF DESCRIPTION OF THE INVENTION

In one aspect, a method of controlling electrical energy in an engine-driven vehicle is provided. The vehicle includes a battery, a propulsive engine, and a starter-generator assembly including a starter-generator coupled to the engine. The method includes supplying an electrical current from the battery to a starting winding of the starter-generator, supplying an electrical current to the battery from a generating winding of the starter-generator, and controlling the voltage of the starter-generator using a unitary, voltage regulator integrated with the starter-generator.

In another aspect, a unitary, integrated starter-generator/voltage regulator assembly for an engine-driven vehicle includes a starter-generator configured to couple to the engine and configured to generate electrical energy when the engine operates and to provide torque to the engine to start the engine when the engine is stopped, and a voltage regulator electrically coupled to the starter-generator to control a voltage output of the starter-generator, the voltage regulator coupled to the starter-generator forming a part thereof.

In yet another aspect, an engine-driven vehicle includes a propulsive engine, a starter-generator coupled to the engine, the starter-generator including a unitary, integral voltage regulator configured to control a voltage output of the starter-generator, and a battery configured to supply electrical energy to the starter-generator when the starter-generator is operating as a starter and to receive electrical energy from the starter-generator when the starter-generator is operating as a generator.

### BRIEF DESCRIPTION OF THE DRAWINGS

FIG. 1 is a side view of an exemplary engine-driven vehicle; and

FIG. 2 is an electrical schematic view of an exemplary embodiment of the starter-generator assembly shown in FIG. 1.

### DETAILED DESCRIPTION OF THE INVENTION

Many specific details of certain embodiments of the invention are set forth in the following description in order to provide a thorough understanding of such embodiments. One skilled in the art, however, will understand that the present invention may have additional embodiments, or that the present invention may be practiced without several of the details described in the following description.

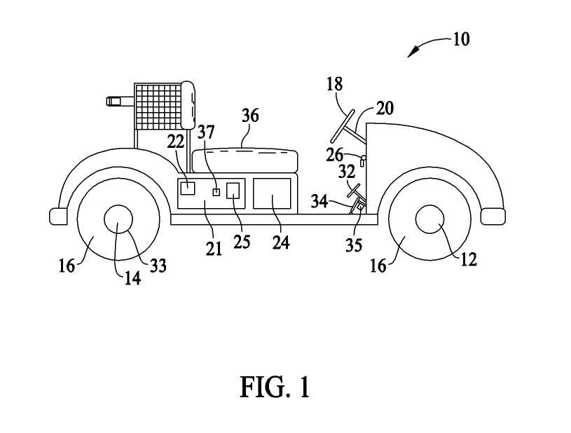

FIG. 1 is an exemplary illustration of an engine-driven vehicle 10, such as a golf car 10 in accordance with an embodiment of the present invention. Golf car 10 includes at least one front wheel 12, and a plurality of rear wheels 14 with a tire 16 mounted on front wheel 12 and rear wheels 14. In the exemplary embodiment, golf car 10 includes two front wheels 12 that are controlled by an operator using a steering wheel 18 or other steering device through a mechanical linkage 20 coupled to front wheels 12. Golf car 10 also includes an engine 21 and an engine control circuit 22 and at least one battery 24 that is electrically connected to engine 21 through control circuit 22 to facilitate providing electrical energy to start engine 21. A starter-generator assembly 25 is coupled to engine 21 to start engine 21 when electrical energy is applied to starter-generator assembly 25. After starting, starter-generator assembly 25 acts as a generator to supply electrical power to battery 24 and auxiliary electrical circuits of golf car 10. An ignition switch 26 is electrically coupled to control circuit 22, and permits power to be supplied from battery 24 to starter-generator assembly 25. Golf car 10 also includes an accelerator pedal 34. Accelerator pedal 34 is connected to engine 21 through a mechanical linkage or an electrical conduit to regulate a flow of fuel to engine 21 to control the speed and power output of engine 21. In the exemplary embodiment, accelerator pedal 34 includes a pedal activated switch 35 that indicates to engine control circuit 22 a desire for engine power wherein if engine 21 is shutdown, pedal activated switch 35 transmits a signal to a solenoid 37 that connects battery 24 to starter-generator assembly 25 through solenoid switch 37. When engine 21 is started solenoid 37 disconnects starter-generator assembly 25 from battery 24. In use, a driver (not shown) seated on a seat 36 turns key 26 to an “on” position and depresses accelerator 34 to start engine 21 to cause golf car 10 to begin moving.

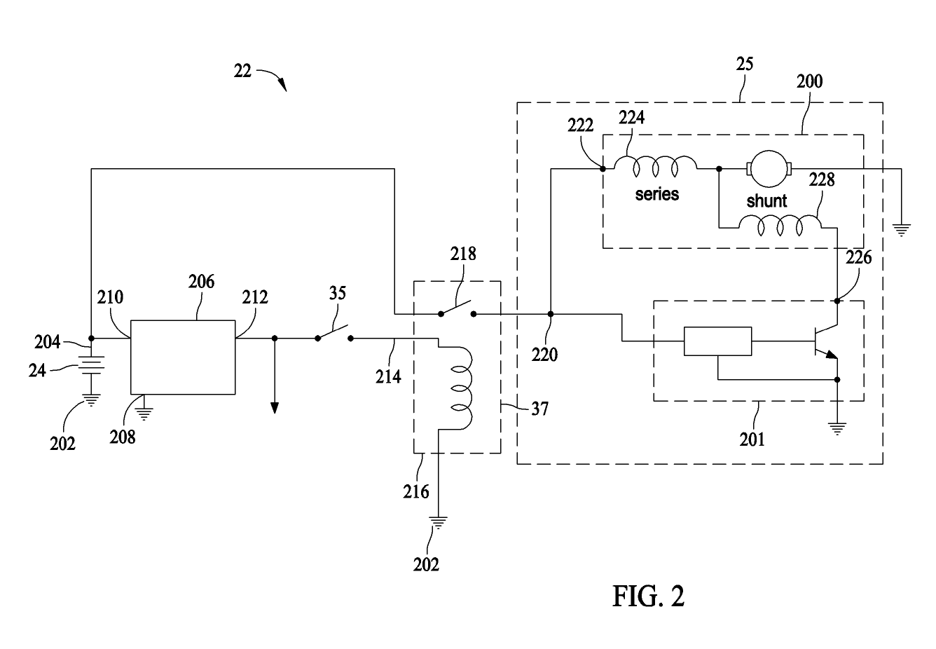

FIG. 2 is an electrical schematic view of an exemplary embodiment of starter-generator assembly 25 (shown in FIG. 1). Starter-generators such as starter-generator assembly 25 are used in utility vehicles and equipment having internal combustion engines such as golf car 10. In the exemplary embodiment, starter-generator assembly 25 includes a starter-generator 200 and an integral voltage regulator 201 built onto or within starter-generator assembly 25. Starter-generator 200 is an electromagnetic machine that combines the functions of a starter motor and a generator in a single device. Starter-generator 200 is configured to start engine 21 and, once engine 21 is running, operate as a generator of electrical power. The generated electrical power is used to recharge battery 24 and to power devices within or connected to vehicle 10. Starter-generator assembly 25 is controlled by engine control circuit 22. Integral voltage regulator 201 is coupled to or fabricated along with starter-generator 200 form an integral unitary starter-generator assembly 25. Voltage regulator is configured to control the voltage level of the generated electrical power, in one embodiment, by sensing an output voltage of starter-generator 200 and controlling a current flowing through a field winding of starter-generator 200.

Starter-generator circuits may also interact with other components of golf car 10. For example, golf car 10 is equipped with pedal-actuated-starter-generator circuits, such as control circuit 22 shown in FIG. 1. Control circuit 22 includes a ground 202, battery 24 with a positive terminal 204, and a two-position key switch 206. Switch 206 includes a ground terminal 208, a battery terminal 210, and an accessory terminal 212. The switch can be placed in one of two positions—an off/position and a run/accessory power position. When in the off position, switch 206 is open such that no power flows from battery 24. When in the run/accessory power position, switch 206 couples battery terminal 210 to accessory terminal 212. In this position, power from the battery may be supplied to accessories (such as lights, a radio, etc. in golf car 10) and to starter-generator assembly 25.

Pedal activated switch 35 is connected to accessory terminal 212. When pedal activated switch 35 is closed such as when a driver steps on an accelerator pedal 34 of golf car 10, battery terminal 210 is coupled to a first inductor coil terminal 214 of solenoid 37. A second inductor coil terminal 216 of solenoid 37 is coupled to ground 202. When pedal activated switch 35 is activated solenoid 37 is energized such that a solenoid switch 218 is closed. When closed, solenoid switch 218 couples positive terminal 204 of battery 24 to a node 220. Node 155 is coupled to a terminal 222 of starter-generator 25. Terminal 222 is coupled to a series winding 224 of starter-generator 25. Starter-generator 25 is coupled to engine 21. When engine 21 is off, starter-generator 25 acts as a starter and uses power supplied from battery 24 to start engine 21. Once engine 21 starts and the engine speed reaches a predetermined level, starter-generator 25 acts as a generator and generates current that may be used to recharge battery 24.

Starter-generator 25 is coupled to a transistor terminal 226 of voltage regulator 201. Voltage regulator 201 is coupled to the node 155 and regulates the voltage applied to the battery 112 by selectively controlling current through a shunt field winding 228.

In an alternative embodiment, starter-generator assembly 25 is switch actuated through for example, a pushbutton switch. Similar to a pedal-actuated-starter-generator circuit, the pushbutton switch actuated starter-generator circuit is coupled to starter-generator assembly 25 through solenoid relay 37.

The above-described unitary, integrated starter-generator assembly is cost-effective and highly reliable for controlling a generator output voltage of a vehicle generator. Specifically, combining a generator voltage regulator in a common device with the starter-generator facilitates reducing a number of components used, a number of wires and connections, frame space for mounting the voltage regulator, and facilitates simplifying installation and maintenance. As a result, the methods and apparatus described herein facilitate reducing electric vehicle fabrication and maintenance costs while facilitating vehicle reliability in a cost-effective and reliable manner.

While the invention has been described in terms of various specific embodiments, those skilled in the art will recognize that the invention can be practiced with modification within the spirit and scope of the claims.

What is claimed is:

1. A method of controlling electrical energy in an engine-driven vehicle, the vehicle including a battery, a propulsive engine, and a starter-generator assembly comprising a starter-generator coupled to the engine, said method comprising:
supplying an electrical current from the battery to a starting winding of the starter-generator;
supplying an electrical current to the battery from a generating winding of the starter-generator; and
controlling the voltage of the starter-generator using a unitary, voltage regulator integrated with the starter-generator.

2. A method in accordance with claim 1 wherein the vehicle comprises a golf car.

3. A method in accordance with claim 1 further comprising generating electrical energy using the starter-generator when the engine operates.

4. A method in accordance with claim 1 further comprising providing torque to the engine to start the engine when the engine is stopped.

5. A method in accordance with claim 1 further comprising:
coupling the starting winding in series with an armature of the starter-generator;
coupling a first lead of the generating winding to the starting winding and the armature; and
coupling a second lead of the generating winding to a transistor in the voltage regulator through a connection internal to the starter-generator.

6. A method in accordance with claim 1 wherein coupling a second lead of the generating winding to a transistor in the voltage regulator comprises coupling a second lead of the generating winding to a collector of the transistor using a connection internal to the starter-generator.

7. A method in accordance with claim 1 further comprising coupling a ground connection of the voltage regulator to the armature internal to the starter-generator.

8. A unitary, integrated starter-generator/voltage regulator assembly for an engine-driven vehicle, said starter-generator/voltage regulator assembly comprising:
a starter-generator configured to couple to the engine and configured to generate electrical energy when the engine operates and to provide torque to the engine to start the engine when the engine is stopped; and
a voltage regulator electrically coupled to said starter-generator to control a voltage output of said starter-generator, said voltage regulator coupled to said starter-generator forming a part thereof.

9. An assembly in accordance with claim 8 wherein said starter-generator comprises an outer casing, said voltage regulator coupled to an external surface of said starter-generator.

10. An assembly in accordance with claim 8 wherein said starter-generator comprises an outer casing, said voltage regulator coupled to an internal surface of said starter-generator.

11. An assembly in accordance with claim 8 wherein said starter-generator comprises an outer casing and an end cap, said voltage regulator coupled to an external surface of said end cap.

12. An assembly in accordance with claim 8 wherein said end cap comprises a commutator end shield.

13. An assembly in accordance with claim 8 wherein said starter-generator comprises an outer casing and an end cap, said voltage regulator coupled to an interior surface of said end cap.

14. An assembly in accordance with claim 8 wherein said voltage regulator is electrically coupled to said starter-generator through electrical wires completely internal to said voltage regulator and said starter-generator.

15. An engine-driven vehicle comprising:
a propulsive engine;
a starter-generator assembly coupled to said engine, said starter-generator assembly comprising a starter-generator and a unitary, integral voltage regulator configured to control a voltage output of a generator portion of said starter-generator; and
a battery configured to supply electrical energy to said starter-generator when said starter-generator assembly is operating as a starter and to receive electrical energy from said starter-generator when said starter-generator assembly is operating as a generator.

16. A vehicle in accordance with claim 15 wherein said voltage regulator is coupled directly to an external surface of said starter-generator assembly.

17. A vehicle in accordance with claim 15 wherein said voltage regulator is coupled directly to said starter-generator using a connection completely internal to said starter-generator assembly.

18. A vehicle in accordance with claim 15 wherein said starter-generator assembly comprises a casing surrounding a stator and a rotor, said voltage regulator positioned within the casing.

19. A vehicle in accordance with claim 15 wherein said voltage regulator is coupled directly to an external surface of said starter-generator assembly.

20. A vehicle in accordance with claim 15 wherein said starter-generator assembly comprises a commutator end shield, said voltage regulator coupled to said commutator end shield.
